(19) United States
(12) Patent Application Publication
(10) Pub. No.: US 2001/0032233 A1
(43) Pub. Date: Oct. 18, 2001

(54) Efficient implementation of several independent state machines in the same process

(76) Inventors: Knut Bakke, His (NO); Geir Olav Evensen, Nedenes (NO); Parastoo Mohagheghi, Grimstad (NO)

Correspondence Address: NIXON & VANDERHYE P.C., 8th Floor, 1100 North Glebe Road, Arlington, VA, 22201, US

(21) Appl. No.: 09/820,166

(22) Filed: Mar. 29, 2001

(30) Foreign Application Priority Data
Mar. 30, 2000 (NO) 20001655

(51) Int. Cl. G06F 15/16

(52) U.S. Cl. 709/201

(57) ABSTRACT

The invention relates to a process control in telecommunication systems, in particular GPRS. The invention is a system and a method for implementing several independent state machines in the same process. It describes how to organise the state machines in a tree, how they access their data and how to offer them some generic support, such as informing them of a common event.

### TECHNICAL FIELD

The present invention relates to computerized process control in general, and in particular the solving of telecommunication tasks (like performing an attachment), and still more specifically the implementation of the Ericsson GPRS application.

### TECHNICAL BACKGROUND

Introduction

Solving a typical telecommunication task usually involves sending messages between several modules. Each of these modules has their own data and may implement a state machine. In the classic approach, these state machines run on different processes and all communication between them must be of asynchronous nature to avoid deadlocks, even when the aim is to fetch data. This method has some drawbacks as:

Several states are defined in the state machines to handle the asynchronous communication

The state machines must in the mean time be prepared to handle any outer event

Cashing and copying data is necessary

There is no efficient way to inform all these modules of a common event

Architecture of the GPRS system

General Packet Radio Services (GPRS) offer packet switched data services to the GSM-based systems. GPRS is designed to work with the existing GSM infrastructure and using GSM nodes as HLR and VLR, while adding additional nodes to the system for handling packet switched data (see FIG. 1). These nodes are:

SGSN=Serving GPRS Support Node

GGSN=Gateway GPRS Support Node

PTM-SC Point to Multipoint Service Centre

SGSN is the interface towards the Base Station Subsystem (BSS) and provide functionalities like:

Packet routing and transferring to and from the SGSN area

Session management

Mobility management

Connection to HLR, MSC, BSC, GGSN

Charging, ciphering, authentication

GGSN is the interface towards the external IP packet networks and offer functionalities like:

GPRS session management

Functionality for connecting the subscriber to the right SGSN

Charging

Both the SGSN and GGSN are denoted the more general notion GPRS Support Node (GSN). Ref. 2 gives a description of GPRS.

GPRS is an independent system and includes three components: the GPRS application, NOC (Network element Object Control) and various services. GPRS applications are TC (Traffic Control) applications and RD (Resource Deployment) applications that use services offered by NOC. In a vertical view, the system is divided in three layers: TC, NOC and RD layers. The TC layer contains functionalities like mobility and session management. The RD layer handles payload processing and all external interfaces. Both the RD and TC layers may contain generic functionality as well as charging or lawful interception.

Object-oriented design methods and tools are used in the software development project. When a subscriber attaches to a SGSN, a Connection Identity (Cid) is assigned to the MS, and several objects are instantiated in each layer to handle different tasks for this MS. All these associated objects constitute a Connection. See FIG. 2. The Connection Broker concept developed in the project enables the objects within a connection to communicate efficiently. The connection broker concept and implementation are described in details in the Norwegian Patent Application No. 19993699. The implementation is based on developing an ORB claiming knowledge about related objects.

Different programming languages are used in the GPRS project. The TC and NOC layers (also called the control system) are developed in Erlang to achieving robustness. Part of the RD layer for handling payload traffic (called the transmission system) is developed in C to achieve high throughput. The other part which is used to adapt to the various underlying switching technologies, is also developed in Erlang.

Erlang is chosen as the implementation language of the traffic control part, because of its robustness and the support it offers for programming concurrent, soft real-time and distributed systems. Erlang has a process-based model of concurrency (Ref. 1) with asynchronous message passing, that is the transmission process continues as soon as the message has been sent. When message passing is asynchronous, synchronisation is obtained by requiring a reply to a message. Processes in Erlang are lightweight; i.e. they require limited memory, and creating and deleting processes and message passing require little computational effort. The functions in Erlang are packed in software packages called modules.

Norwegian patent application No. 19993699 belongs to the same applicant.

The Problem Area

Several objects are instantiated in the GPRS system to handle different tasks for a connection, such as handling session and mobility management. Some of these objects implement state machines that may need synchronisation. As these objects are all associated to the same connection, there may be events that affect several or all of them. Besides, there is a need to terminate all objects associated with a connection when the connection is removed from the GPRS system.

There are also objects in the system that are not connection-specific, but handle many connections. Examples are objects instantiated in the NOC layer to handle switching data for many connections, start/restart, etc. These may be stateless, but need some functionality to:

Get informed about termination of a connection to remove connection-specific data

Be able to synchronise their functionality with other parts of the system as in start or restart

Another aspect of the problem in a concurrent system is to handle shared data, i.e. when there are several modules processing data for the same connection, there must be some mechanism to avoid data corruption.

Known solutions

The objects in the GPRS system are implemented in Erlang modules. In the classic approach of concurrent programming, each of the modules or state machines will run on a separate process and all communication between them must be of asynchronous nature to avoid deadlocks, even when the aim is to fetch data. If needed, synchronisation is achieved by requiring a reply to a synchronising message, see FIG. 3. This approach has some serious drawbacks like:

Several states are defined in the state machines to handle asynchronous communication

When the state machine is waiting for the response of a message, it must in the mean time be ready to handle any outer event

Copying data is necessary for interprocess communication

To inform several modules of a common event, a message should be sent to each of them, which affects the system load

OMG's Corba Standard specifies the architecture for object communication in general. Norwegian Patent Application No. 19993699 discloses how objects associated with a Cid are controlled in the GPRS project, e.g. all objects terminate if one of them terminates or restores to a stable state. This is achieved by implementation of an ORB with knowledge about associated objects. The objects may be running on the same process or not, i.e. implementation of the objects is not subject of the Norwegian Patent Application No. 19993699.

German patent application DE 4401492 (Siemens) discloses a method for computerised process control involving several independent objects. A continuously circulating state machine accepts input conditions, modified stored internal states, and generates output signals. Each object has stored a specific state independent from states of other objects. Each state set is instantiated only for the processing time to update the outputs.

The invention

Objects of the invention

An object of the present invention is to implement several independent objects (state machines) on the same process, and avoiding the shortcomings of prior art systems as mentioned above.

In particular, the inventive system tries to achieve a reduced number of states in the state machine when handling asynchronous communication to avoid copying data, and achieve a homogenous programming mode 1.

These objects are met in a system according to the invention for processing process data for a client, said system comprising multiple modules each including a state machine, in which:

The modules are independent and structured in a tree,—the module tree, said tree comprising a root module having an interface (facade) towards the client and an output connected to at least one module on the next (higher) level of the tree, and individual modules receiving input from one lower module and output to at least one other module on the next level in the tree, said processing data is organised as a vector comprising individual elements of module data, each element belonging to a corresponding module and which can not be accessed by other modules

The modules are adapted to communicate by synchronous function's calls, in which call's pointers to modules of the processing data vector is passed, by which copying module data is avoided.

The described method has wide application in the control system (both IC and NOC layers) of a GPRS application.

However, the solution is in fact applicable in any use where several state machines are executing, whether they are logically related or not.

### BRIEF DESCRIPTION OF THE DRAWINGS

The invention will now be described in detail by means of several embodiments or examples. Reference is made to the appended drawings, in which:

FIG. 1 shows the architecture of a circuit and packet switched GSM network (prior art)

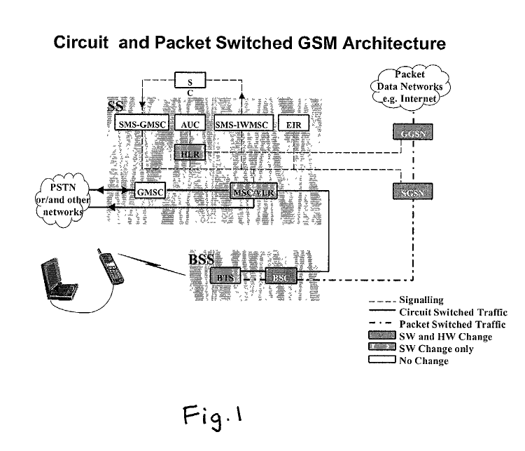

FIG. 2 shows how objects for a single connection are interconnected by means of connection identity (CID) (prior art)

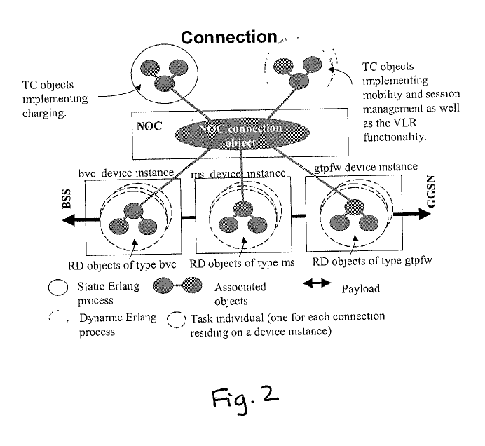

FIG. 3 shows a comparison of programming models according to a NOC implementation and a classic implementation (prior art)

FIG. 4 shows the structure of a module tree according to the invention, and how it might be traversed during a process

FIG. 5 shows NOC support's objects in the TC layer via the Application Adapter interface

### THE INVENTION

Description

The GPRS applications developed in the GPRS project by Ericsson, use the facilities offered by the NOC layer for event handling, persistent data handling, start/restart, etc. The NOC programming model is developed to benefit from a homogeneous implementation and solving the above problems,.

The foundation of the NOC programming model is to enable multiple independent modules running on the same process. A module is a self-contained unit, which executes its own state machine.

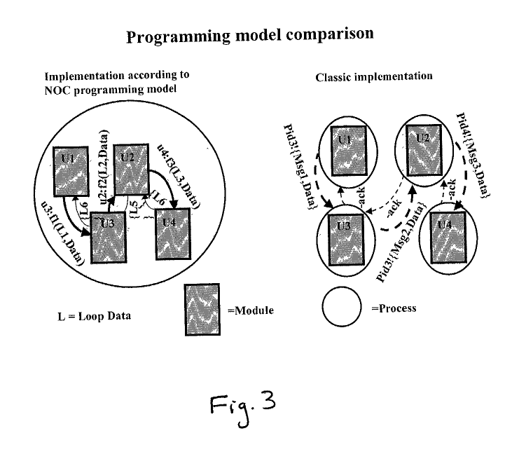

The communication between these modules will always be of a synchronised nature (function calls). The pointer of the processing data (called loop data) is passed in the function calls and, hence, the data is not copied. Since the client hangs when it has done a synchronous call, it does not need to change state or handle any outer event, see FIG. 3.

As several modules may be running on the same process, an efficient mechanism is developed in the GPRS project to inform modules of a common event. This is done by structuring the modules running on the same process in a tree (called module tree) and traversing the tree with an operation. Examples of such common events are:

Initialisation of the process where each module must perform some action

Termination of the process

Messages addressed to the process that may affect several modules

Storing persistent data of the connection

The module tree concept provides a mechanism to inform all modules of the tree (tree modules) of such events. Each tree module individually decides how to act upon the event.

A process is a container for process data, which here is called loop data. When there are several modules running on the same process, a mechanism is needed to provide data accuracy and avoid modules accessing data owned by other modules. The NOC programming model allows each module to run on a common process to act as a data container, as the data structure is being owned by the module. Each module organises its data as a record with the same name as the module (called module data). Module data is not allowed to be accessed by other modules. The loop data is seen as a vector containing several elements (module data), where each module can access its data by using a unique module reference.

Advantages

Some of the advantages are:

Reduced number of states in the state machines; i.e. the client state machine does not change state when it handles a synchronous call

Copying data is not necessary: the pointer to the loop data is passed in the function calls

Communication to all modules on the same process is possible by traversing the module tree

Access to the process data is organised; no module can access data owned by another module

Number of processes started on a processor and, hence, messages passing between the processes (which is costly for a system with many processes) is reduced.

A homogenous programming model is achieved

It is easy to add new modules to a module tree and they will be offered the same support as other modules on the same process without having to modify data access and communication procedures

### EXAMPLES

### Example 1

The module tree implementation

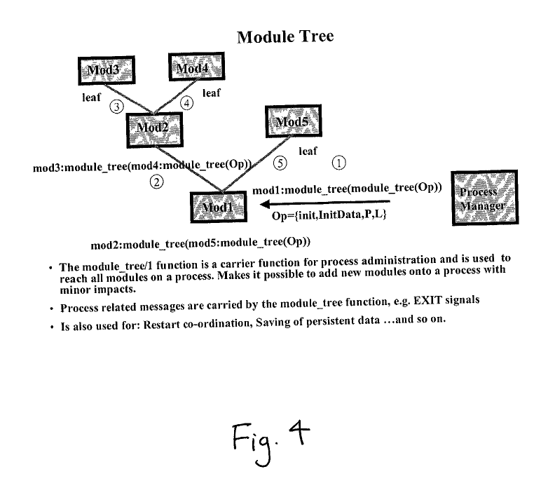

FIG. 4 shows an example of a module tree where the module_tree function, carrying an operation, is traversing the tree. Each process has a root module that is invoked by the client through a facade. The facade module acts as a dispatcher by sending the invocation to all the objects. Each module may act individually upon the invocation.

### Example 2

Objects in the TC layer

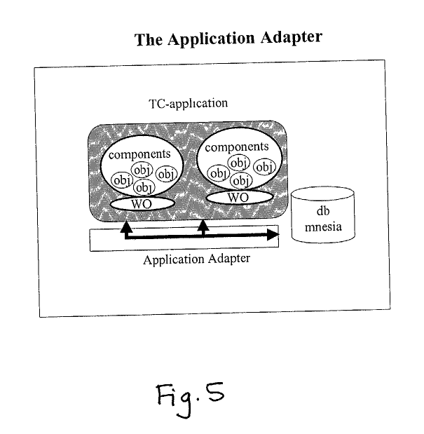

One Erlang process is started in a NE per connection (mobile station). In this process, several modules implement the TC objects. Each of the modules owns their own data structure (e.g. mobility management data, session management data etc.). The NOC layer highly supports state machine handling in the system (e.g. transaction handling), starting and restarting the process, redundancy etc., via the Application Adapter. This interface consists of generic functionality implemented in all layers as the module tree mechanism, and functionality only implemented in the TC layer (e.g. transaction handling), see FIG. 5.

### Example 3

Loop data definition

Each module (here called mod_{—}1) in the tree is assigned an unique module reference:

Define (module_ref,3)

Each module owns a record in the loop data vector, L:

Record(mod_{—}1, {state,appl}).

The macros are defined to initiate, read or write the loop data (L), such as:

L1=?replace_md(L,#mod_{—}1 {appl=msc}). %% Field “appl” is now set to be “msc”. Other fields are undefined.

L is passed in function calls between modules running on the same process as:

{ok,L1}=mod_{—}1:detach_request(L).

Abbreviations

Cid Connection Identity

GSN GPRS Support Node

GGSN Gateway GPRS Support Node

MS Mobile Station

NE Network element

NOC Network element Object Control

ORB Object Request Broker

RD Resource Deployment

SGSN Serving GPRS Support Node

TC Traffic Control

References

[1] Concurrent Programming in ERLANG, Joe Armstrong & Robert Virding & Claes Wikstrøm & Mike Williams, 2^{nd} edition

[2] ETSI GSM standards on GPRS

1. System for processing process data for a client, said system comprising multiple modules, wherein each including a state machine,
characterized in that
the modules are independent and structured in a tree, the module tree, the tree comprising a root module having an interface (facade) towards the client and an output connected to at least one module on the next (higher) level of the tree, and individual modules receiving an input from one lower module and an output to at least one other module on the next level in the tree, said processing data is organised as a vector comprising individual elements of module data, each element belonging to a corresponding module which can not be accessed by other modules
the modules are adapted to communicate by synchronous function calls, in which the call's pointers to modules of the process data vector is passed, by which copying module data is avoided.

2. Use of a system according to claim 1, the NOC layer of a GPRS application, and other applications based on it.

3. Method for computerised process control involving multiple modules, each including an independent state machine,
characterized in:
organising the modules in a hierarchical tree (the model tree) including a root module having an interface towards a client
communicating between the modules by passing a pointer to process data in function calls.

4. Method as claimed in claim 3,
characterized in that the modules are informed of a common event by traversing the module tree with an operation.

5. Method as claimed in claim 4,
characterized in that the process data is organised as a vector containing elements, in which each element comprises process data for each module, which individual module data is not allowed to be accessed by other modules.
